(19) United States
(12) Patent Application Publication
(10) Pub. No.: US 2021/0351735 A1
(43) Pub. Date: Nov. 11, 2021

(54) MOBILE GENERATOR DEVICE AND COOLING SYSTEM

(71) Applicant: B MEDICAL SYSTEMS S.A.R.L., Hosingen (LU)

(72) Inventors: Andreas Hoffmann, Ammeldingen (DE); Admilson PINTO, Aach (DE); Uwe SCHRAMER, lrrel (DE)

(21) Appl. No.: 15/801,968

(22) Filed: Nov. 2, 2017

Related U.S. Application Data
(63) Continuation of application No. 14/367,844, filed on Sep. 19, 2014, now abandoned.

(30) Foreign Application Priority Data
Dec. 20, 2011 (DE) 10 2011 121 553.4

(51) Int. Cl. H02S 10/40; H02S 30/20; H02S 20/00; H02S 20/30; F24S 25/11

(52) U.S. Cl. CPC H02S 10/40; H02S 30/20; H02S 20/00; F25B 27/005; F24S 25/11; Y02E 10/50; H02S 20/30

(57) ABSTRACT

The present invention relates to a mobile generator device (1) having at least one alignable solar panel (2a, 2b), wherein the solar panel (2a, 2b) can be moved in a transport position (TP) and at least one operating position (BP). The invention is characterized in that the generator device (1) has a housing shell (3a) with a peripheral area (4), wherein the solar panel (2a) is hinged to the housing shell (3a) so that the solar panel (2a) is in the transport position (TP) within the housing shell (3a) and does not project over the peripheral area (4). Moreover, the invention relates to a cooling system having the mobile generator device (1) according to the invention and a control, and a cooling device, in particular a freezer, having at least one cooling circuit, wherein the cooling circuit has a compressor, an evaporator, and a condenser. The cooling system according to the invention is characterized in that the power supply of the cooling system is provided by the mobile generator device (1) and the control regulates the cooling system in dependence of the power supply.

This application is a continuation of U.S. patent application Ser. No. 14/367,844, filed Sep. 19, 2014, the entirety of which is incorporated by reference herein.

The present invention relates to a mobile generator device having at least one alignable solar panel, wherein the solar panel can be moved to a transport position and at least one operating position, and a cooling system with a mobile generator device, a control and a cooling device, in particular a freezer, having at least one cooling circuit, wherein the cooling circuit has a compressor, an evaporator, and a condenser.

Typically, such generator devices and cooling systems are employed in remote areas, in particular in developing countries where a stable and safe energy supply under normal circumstances cannot be ensured. It has therefore turned out feasible to photovoltaically generate the energy required for the operation since in the most developing countries the insolation is sufficiently high over the whole year. Thus, also delicate goods, such as for example medical products that need to be cooled can be stored safely, whereby the quality of life of the local people can be improved.

To counteract this, the World Health Organization (WHO) has made a catalogue with threshold criteria which has to be fulfilled by the used generator device and cooling equipment for the transport and storage of medical products. However, with the generator devices of the prior art meeting these criteria this means that as a rule predefined installation set-ups are required for operation. For example, the solar panels are anchored on a base pedestal or attached to walls and roofs. However, in remote areas there is often a lack of the infrastructure that is required for installation and starting up. Occasionally, qualified staff such as electricians, mechanics, welders, or bricklayers must be externally included for the installation and starting up of the plant. This makes the plant expensive and also causes problems in maintenance and upkeep. Moreover, because of this the known plants can in no way be flexibly employed but only used stationary and again it requires a great effort to move such devices, respectively.

Moreover, the known devices are difficult to transport and there often occur damages in transport to the delicate solar panels, in particular when the transport leads through difficult terrain or also water.

Thus, it is the object of the present invention to provide a mobile generator system for the photovoltaic power generation that fulfills the criteria of the WHO and at the same time, does not need any installation setups, can be easily transported, and in which transport damages to the solar panels can be avoided. Furthermore, it is the object of the present invention to provide a cooling system the power supply of which is provided by a mobile generator system according to the invention.

The solution of the object is accomplished with a mobile generator device according to claim 1 and a cooling system according to claim 18. Practical developments are described in the dependent claims.

The mobile generator device according to the invention is distinguished from the generator devices known in the prior art in particular by the fact that the generator device has a housing shell with a peripheral area, wherein the solar panel is hinged to the housing shell so that the solar panel is in the transport position within the housing shell and does not project over the peripheral area. With other words, for transport the solar panel can be pivoted into the shell. Thus, the panel is safely protected against shock and/or other transport damages. Moreover, this also allows the simple and easy transportation of the generator device by air, water, and ashore since the generator device does not need any installation setups. By the shell-like construction it is also possible to optimally align the plant towards the sun since the shell can be rotated without major problems.

Preferably, the generator device has a further housing shell with a peripheral area. The further housing shell is connected to the other housing shell by a housing hinge connection so that the peripheral area of the further housing shell can be contacted with the peripheral area of the other housing shell. Thus, the solar panel in the transport position can be even better protected against damages since it is located inside the shell. Here, it is conceivable that the peripheral areas of the housing shells are fixed to each other by suitable locking means.

Moreover, the further housing shell can have at least one alignable solar panel, wherein the solar panel is hinged to the further housing shell so that the solar panel in the transport position is within the further housing shell and does not project over its peripheral area. In this way, the available solar panel surface—and thus, the power yield of the generator device—can be significantly increased. Here, the housing shells preferably are substantially mirrored and identical, respectively, so that the advantages already mentioned-above also apply.

Furthermore, it can also be advantageous if the housing hinge connection is detachable. In this way, both shells can be moved separately. In particular, when solar panels are disposed in both shells this allows an individual alignment of the solar panels.

It is practical if each solar panel has a transport locking device so that the solar panel can be fixed in its transport position within the housing shell. In this way, the protection against damage can be increased again. Here, it is particularly advantageous if the transport locking device has a simple construction and can be accomplished by manually screwing in a thumb or knurled thumbscrew, for example.

Preferably, for each solar panel the generator device has at least one rail disposed within the housing shell and one connecting arm assigned to the rail. Here, the solar panel is connected to one end of the rail by a panel hinge connection. The rail extends vertically towards the rotational axis of the panel hinge connection. The connecting arm is connected to the solar panel by a first hinge at its first end and to a slide by a second hinge at its second end, wherein the slide can be moved along the rail such that the solar panel can be continuously aligned in various operating positions. This has the advantage that the inclination of the solar panel can be adjusted by simply shifting the slide. Thus, the solar panel can be quickly and easily brought into the desired operating position and aligned towards the sun, respectively.

Furthermore, it is advantageous if the slide is fixed in its position along the rail. Thus, inadvertent shifting the inclination of the solar panel can be avoided.

Preferably, the rail is detachably connected to the housing shell. This opens the possibility, that the solar panels can also be used without the shell. For example, the solar panels thus can be firmly fixed on a roof or at a wall.

Alternatively, it has been found practical if each solar panel is connected by at least one panel hinge connection to the housing shell and the housing shell has at least one perforated strip. Here, the perforated strip extends vertically to the rotational axis of the panel hinge connection. The solar panel has a connecting arm, wherein the connecting arm is connected to the solar panel via a first hinge at its first end, and the connecting arm has a receptacle for a fastening pin at its second end. The connecting arm can be fixed at different positions along the perforated strip via the fastening pin so that the solar panel can be aligned in different operating positions. This alternative solution has the advantage that the inclination of the solar panel can be adjusted by simply changing the fastening pin. Thus, the solar panel can be quickly and easily brought into the desired operating position and aligned towards the sun, respectively. Moreover, the fastening pin also prevents inadvertent shifting the inclination of the solar panel.

Preferably, the solar panel is detachably connected to the housing shell. This opens the possibility that the solar panel can also be used without the shell. For example, then the solar panels can be firmly fixed on a roof or at a wall.

Preferably, the housing shell is made of a weatherproofed material, in particular of polyethylene. In this way, the shell becomes particularly light and stable. However, it is also conceivable that the shell is made of wood or another metallic material.

It is advantageous if the housing shell has at least one chamber, wherein the chamber can be filled with material to act as a weight. In this way, the structural stability of the generator device can be increased.

Preferably, the housing shell has a multi-wall construction, wherein the housing shell has at least one opening for filling and discharging the housing shell. Thus, the shell can be filled with a liquid, fine gravel, or sand, for example. In the discharged state, this has also the advantage that the shell becomes more rigid and at the same lighter. By the multi-wall construction the generator device can also be designed floatable.

Moreover, at least one housing shell can have transport receptacles, in particular for the transport with an industrial truck or aircraft. In this way, the generator device can easily be raised, moved, and loaded. Here, by an industrial truck in particular a forklift or also a carriage is to be understood.

Preferably, the housing shell has structures for safely stacking several housing shells on top of each other at the outside. This is particularly advantageous in transport and storage of the generator device since thus, it can at least partially be refrained from costly storage and transport locking devices.

It is advantageous if the housing shell has at least one grommet for fixation and/or protection against theft. In this way, the generator device can be even better transported. Here, the grommets are formed such that for example round slings for the hanging transport can be threaded in. It is also conceivable that pegs or the like are driven through the grommets so as to also increase the stability of the generator device and also protect it against theft.

Preferably, the housing shell has a plurality of handles. The handles allow the transport by hand and are also helpful in loading the generator device. Here, it is preferable if corresponding loading means, such as for example belts, can be attached.

Moreover, the present invention relates to a cooling system having a generator device according to the invention and at least one cooling circuit. The cooling system has a control and a cooling device, in particular a freezer. The cooling system is distinguished over the cooling systems known in the prior art by the fact that the power supply of the cooling system is provided by the mobile generator device and the control regulates the cooling system depending on the power supply. This has the advantage that the cooling system fulfills the guidelines and criteria of the WHO and thus, a safe storage of the chilled goods is possible.

In this context, it is also advantageous if the connection between the cooling device and the mobile generator device and/or between individual generator devices is provided via a plug quick connection having a female and male part. Also the single solar panel itself can be connected to the housing shell of the generator device by the plug quick connection. In particular, here cables with corresponding 3P plugs or 3P couplings can be used. If several mobile generator devices are to provide the power supply for the cooling device it is preferably if at least one clamping strip or the like is employed for connecting the generator devices to the cooling device. Here, at least two generator devices can be detachably connected by at least one coupling, wherein the coupling can be directly connected to the cooling device or in turn to another coupling. To thereby prevent incorrect mating the plug quick connections in their shape can accordingly be formed such that it allows only one way of connection. Also, a colored or other indication is conceivable. This makes it possible in an advantageous manner to quickly and simply isolate individual mobile generator devices if those for example are to be employed elsewhere or have a defect. Moreover, the individual solar panel can be separated from the housing shell by means of the plug quick connection so as to exchange it for another solar panel or to mount it for example separately from the housing shell directly on the roof of a house.

In the following, the invention is explained in more detail with respect to examples illustrated in the figures. Here, schematically:

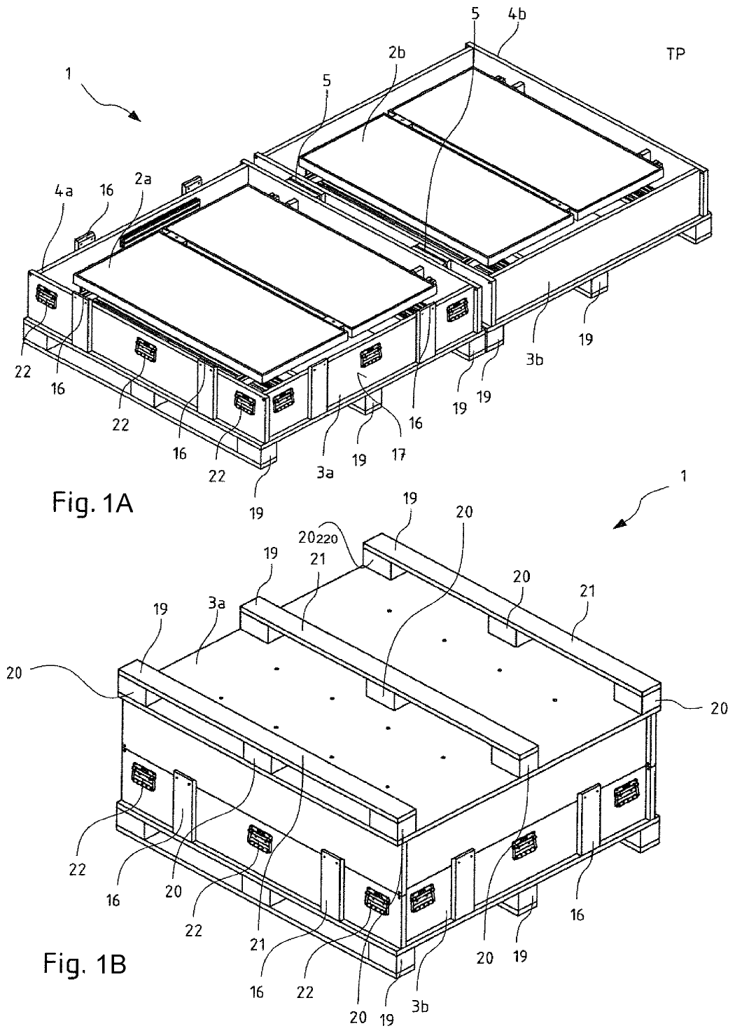

FIGS. 1A-1B shows a first example of a mobile generator device according to the invention;

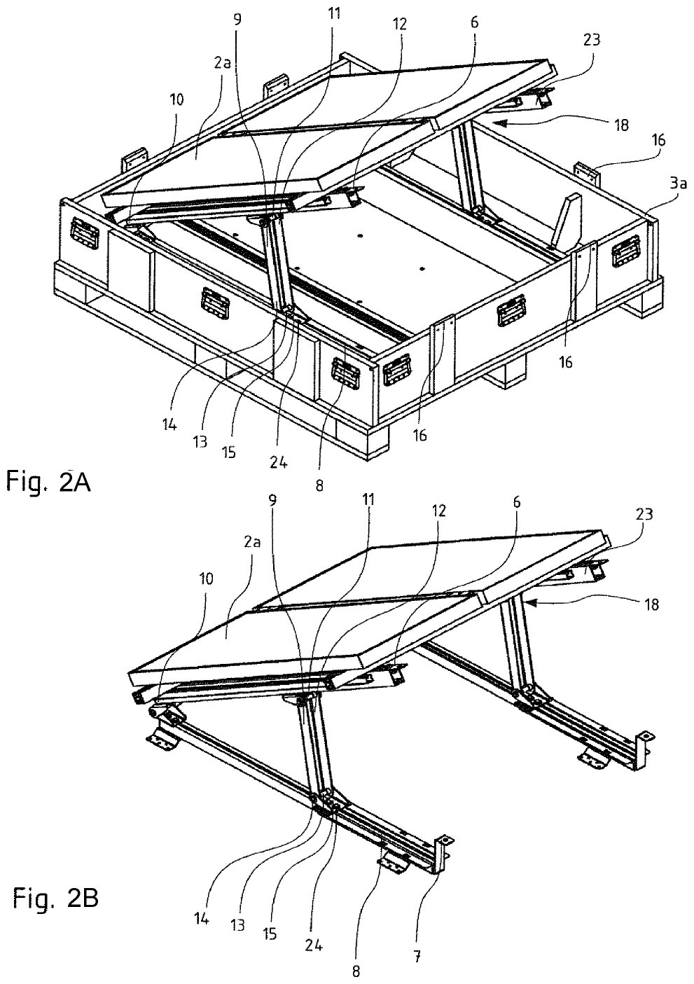

FIGS. 2A-2B shows a detailed view of the adjusting mechanism of the generator device illustrated in FIGS. 1A-1B:

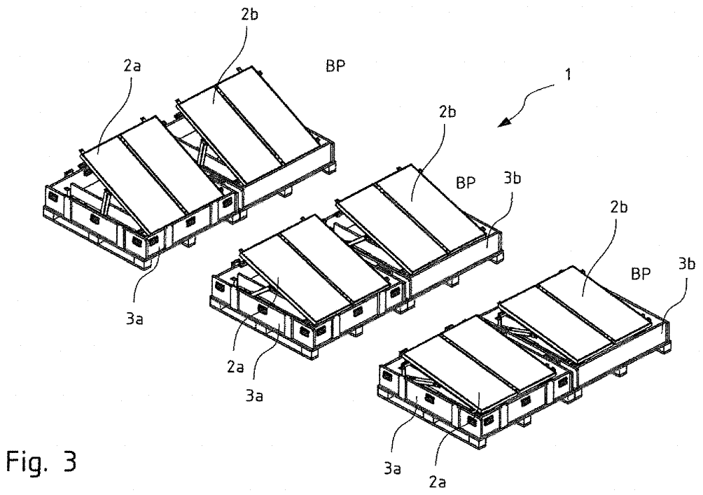

FIG. 3 shows three operating positions of the generator device illustrated in FIGS. 1A-1B:

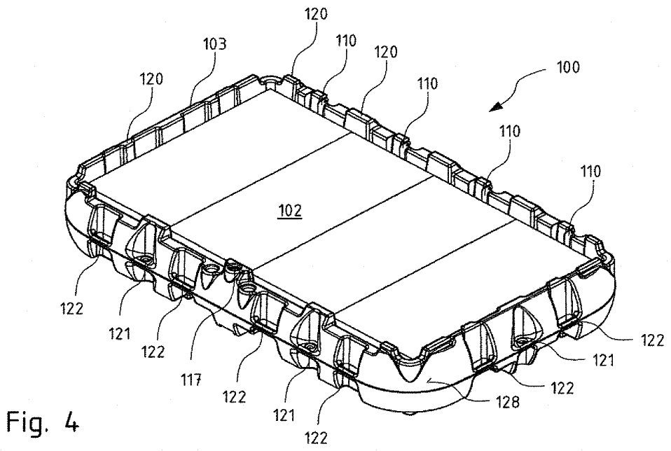

FIG. 4 shows a second example of the mobile generator device according to the invention;

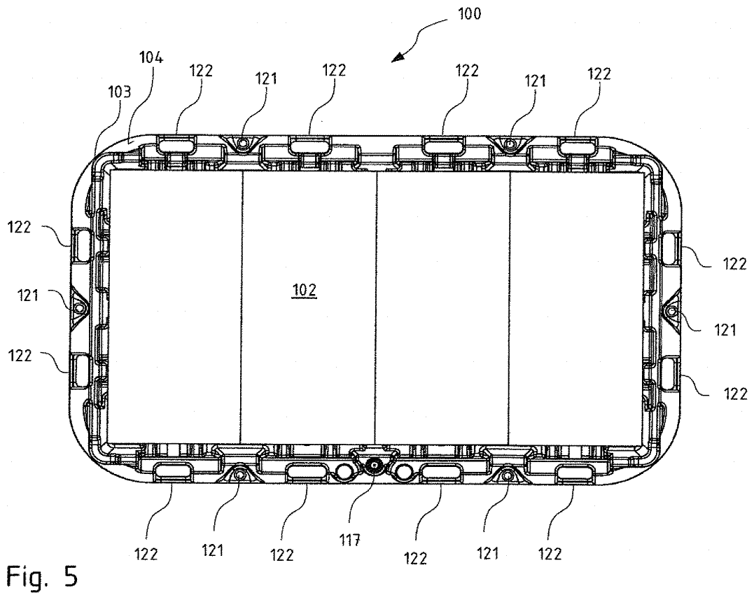

FIG. 5 shows a top view of the generator device illustrated in FIG. 4;

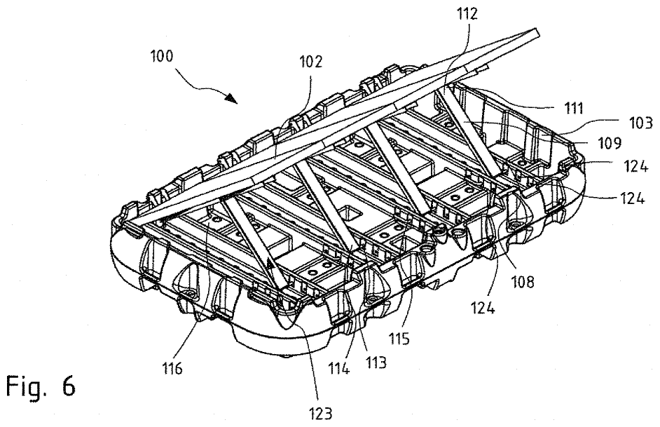

FIG. 6 shows a detailed view of the adjusting mechanism of the generator device illustrated in FIG. 4;

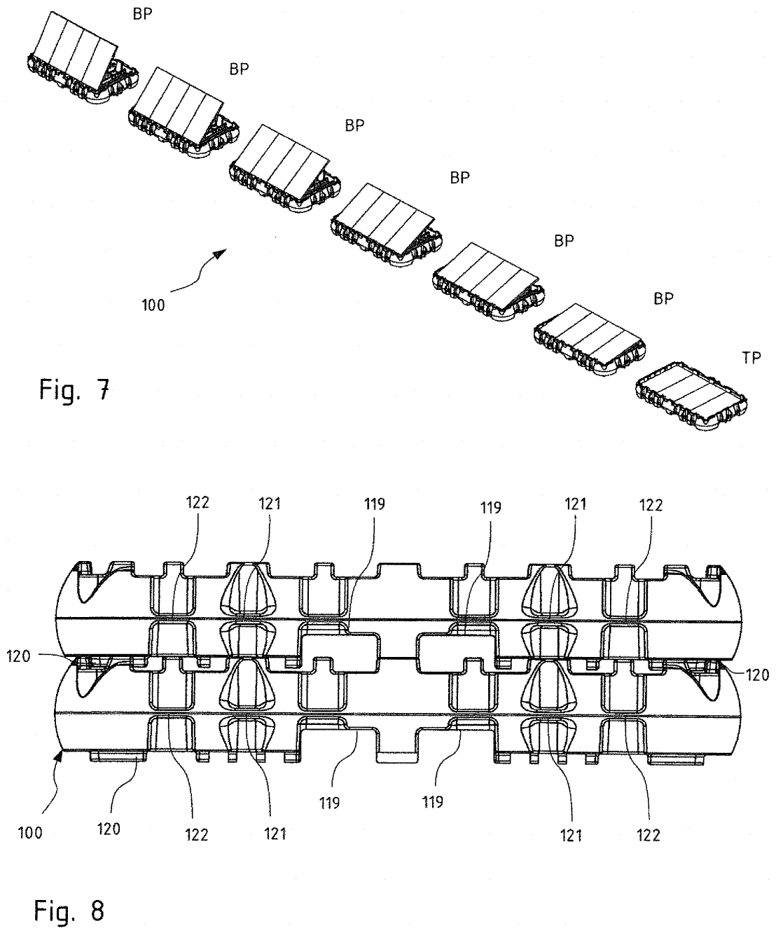

FIG. 7 shows six operating positions and the transport position of the generator device illustrated in FIG. 4;

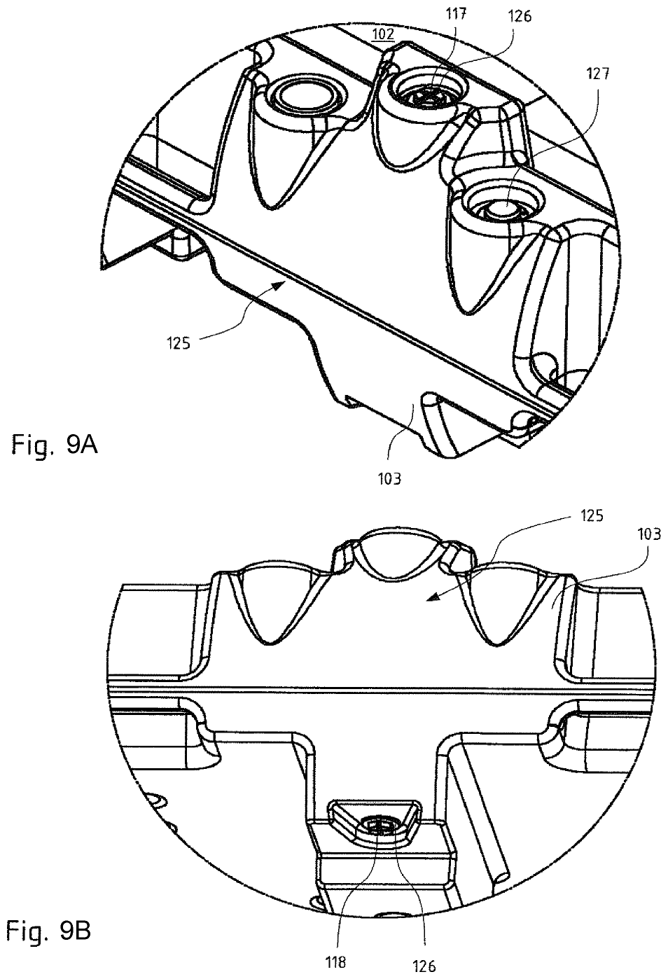

FIG. 8 shows two generator devices, as illustrated in FIG. 4, stacked on top of each other; and

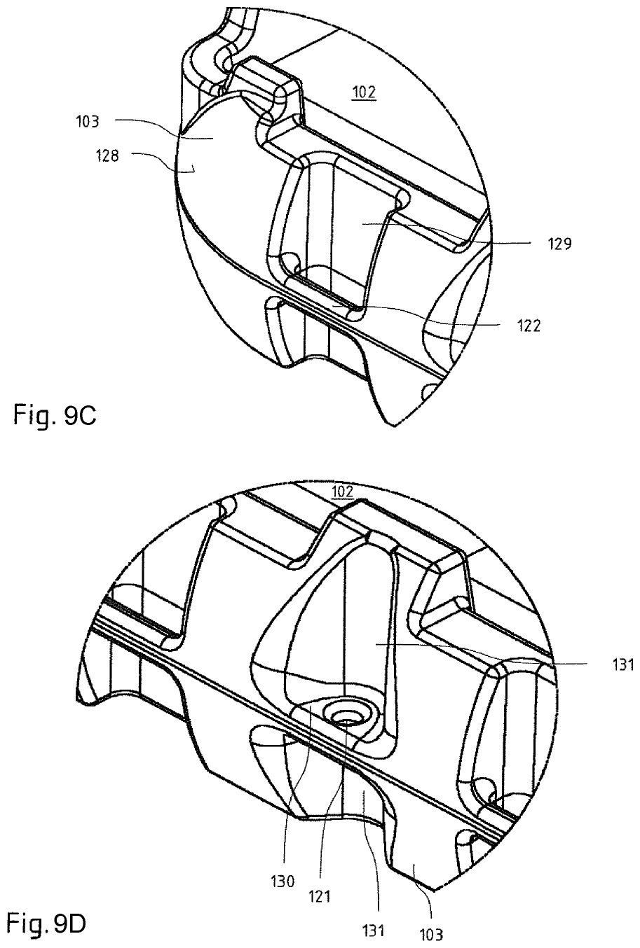

FIGS. 9A-9D shows detailed views of the generator device illustrated in FIG. 4.

In FIGS. 1A to 3 a first example of a mobile generator device 1 according to the invention is illustrated. The generator device 1 shown in FIGS. 1A and 1B has two single-wall housing shells 3a, 3b and two solar panels 2a, 2b, wherein one solar panel 2a, 2b is disposed in each housing shell 3a, 3b. Furthermore, the housing shells 3a, 3b each have a peripheral area 4a, 4b and are connected by joints or hinges 5, respectively. Here, the hinges 5 define a rotational axis by which the housing shell 3b can be moved towards the other housing shell 3a such that the peripheral areas 4a, 4b of the housing shells 3a, 3b come into contact. This state is shown in FIG. 1B.

In the illustration according to FIG. 1A the solar panels 2a, 2b are shown in both shells 3a, 3b in the transport position TP. The solar panels 2a, 2b are disposed within the corresponding housing shell 3a, 3b such that they do not project over the peripheral area 4a, 4b, by which a damage to the solar panels 2a, 2b by folding up the housing shells 3a, 3b is prevented.

Moreover, the housing shell 3a has handles 22 disposed on opposite sides of the housing shell 3a. In this example, at each side three handles 22 are provided. Furthermore, the housing shell 3a has several webs 16 at the outer periphery 17. These webs prevent an offset between the peripheral areas 4a, 4b of the two housing shells 3a, 3b if these are in the folded state. The operating principle of the webs 16 is in particular seen in FIG. 1B. Moreover, the housing shells 3a, 3b have three transport receptacles 19 with each transport receptacle 19 consisting of three blocks 21 and a connection board 21. By the parallel arrangement of the transport receptacles 19 over the entire ceiling and floor surface, respectively, of the housing shells 3a. 3b there arises the possibility to take the generator device 1 from all four sides with an industrial truck or aircraft and transport it, respectively.

In FIGS. 2A and 2B, detailed views of a linearly guided adjusting mechanism 18 according to the invention are shown by means of which the solar panel 2a can be aligned in a changed way between the transport position TP and a number of operating positions BP. Here, FIG. 2B shows the solar panel 2a without the housing shell 3a. In this example, the solar panel 2A is mounted on a frame 23, wherein the alignment of the solar panel 2a takes place by two linear guides. In the following, only one linear guide is described in more detail since both guides are substantially the same. The solar panel 2a and the frame 23, respectively, onto which the solar panel 2a is mounted is with one side connected to a rail 8 via a hinge connection 10.

Here, the rail 8 extends vertically from the rotational axis defined by the hinge connection 10 and parallel to the bottom surface of the housing shell 3a. At the back of the solar panel 2a and the frame 23, respectively, there is fixed a connecting arm 9 with its first end 12 by means of a first hinge 11. The connecting arm 9 with its second end 14 is fixed to a slide 15 by means of a second hinge 13. The slide 15 runs along a profile of the rail 8, in which case a reversed T profile is used. Moreover, the slide 15 has a fastening means 24 by means of which the slide 15 can be fixed in its position along the rail 8. As is illustrated, two screws can be provided for that by means of which the slide 15 can be positively clamped to the rail profile. It is also conceivable that the fastening means 24 are only provided at one slide 15. Thus, the solar panel 2a can be continuously adjusted in its inclination.

Furthermore, in FIG. 2B there is also shown the transport locking device 6, 7 for locking the solar panel 2a in its transport position TP. The transport locking device 6, 7 consists of a first lug 6 with a bore at the free end of the first lug and a second lug 7 with a thread at the free end of the second lug. The first lug 6 is disposed at the solar panel 2a and at the frame of the solar panel 2a, respectively, and the second lug 7 is disposed at the housing shell 3a such that the free end of the first lug 6 contacts the free end of the second lug 7 when the solar panel 2a is in the transport position TP. Then, a threaded screw, in particular a thumb screw, can be screwed into the thread of the second lug 7 through the bore of the first lug 6 and thus, form the transport locking device.

In FIG. 3, the generator device 1 shown in FIGS. 1A-1B is illustrated in different operating positions BP. Depending on insolation and season, respectively, a strong and a rather flat inclination can be chosen as the operating position BP of the solar panels 2a, 2b.

In FIG. 4 to 8, a second example of a mobile generator device 100 according to the invention is shown. Generator device 100 has a multi-wall housing shell 103 with a peripheral area 104 and a solar panel 102 disposed in said housing shell 103. As shown in FIG. 4, the solar panel 102 is supported in the illustrated transport position TP within the housing shell 103 such that it does not project over the peripheral area 104 of the housing shell 103. The peripheral area 104 has a number of structures 120 which can interact with the corresponding structures 120 at the lower side of another housing shell 103 so that several generator devices 100 can be safely stacked on top of each other (see, FIG. 8).

Furthermore, the housing shell 103 has a number of handles 122 and grommets 121 distributed at the outer periphery 128. In this example, twelve handles 122 and six grommets 121 in total are distributed at the outer periphery 128.

As shown in FIGS. 4 and 5, the solar panel 102 is rotatable mounted at the housing shell 103 by four panel hinge connections 110 with the panel hinge connections 110 defining a rotational axis. Along this rotational axis the solar panel 102 can be aligned in the operating positions BP. This happens by the adjusting mechanisms 123 illustrated in detail in FIG. 6. In the following, only one adjusting mechanism 123 is described in detail since the adjusting mechanisms 123 of this example have an identical construction. The housing shell 103 has two parallel perforated strips 108 extending parallel to the bottom surface of the housing shell 103 and vertically to the rotational axis of the panel hinge connections 110. The perforated strips 108 periodically have opposite holes 124. One connecting arm 109 is connected with its first end 112 to the back of the solar panel 102 by a hinge 111 and has a receptacle 113 for a fastening pin 115 at its second end 114. For fixing the position of the connecting arm 109 the fastening pin 115 is put through the holes 124 of the perforated strips 108 and the receptacle 113 of the connecting arm 109. By changing the fastening pin 115 the inclination of the 20 solar panel 102 and thus, the different operating positions BP can be adjusted.

Moreover, in FIG. 6 also a chamber 116 is illustrated into which material to act as a weight can be filled. This increases the structural stability of the mobile generator device 100.

In FIG. 7 there are shown six different operating positions BP of the solar panel 102 as well as the transport position TP. Thus, depending on insolation the solar panel 102 can be continuously adjusted in its inclination.

FIG. 8 shows generator devices 100 stacked on top of each other. Each housing shell 103 has corresponding structures 120 at the peripheral area 104 and the bottom which interact such that several generator devices 100 can be safely stacked. In the stacked state the structures 120 are located at the peripheral area 104 of the lower generator device 100 seen in the direction of the solar panel 102 behind the structures 120 at the bottom of the upper generator device 100. Thus., lateral slipping of the upper generator device 100 is not possible. Moreover, in FIG. 8 there are also shown two channel-like transport receptacles 119 at each generator device 100. Said transport receptacles 119 serve to transport the generator device 100 with an industrial truck. In order to ensure transportability no structures 120 for stacking are provided at the peripheral area 104 above the transport receptacles 119.

In FIGS. 9A-D, enlarged views of various details of the mobile generator device 100 are illustrated. Here, FIGS. 9A and 9B show a filling and discharging facility 125 by means of which liquid or another material, such as for example sand, can be filled into or discharged from the multi-wall housing shell 103. For that, the filling and discharging facility 125 has two valves 117, 118 with a valve 117 pointing upwards (cf. FIG. 9A) and a valve 118 pointing downwards (cf. FIG. 9B) so that filling and discharging can be done by gravity. The valves 117, 118 can have a suitable locking means 126 for closing, for example a threaded locking means or a plug locking means. In order to ensure ventilation of the housing shell upon filling and discharging the filling and discharging facility has a further opening 127 which like valve 117 points upwards. As a result of the multi-wall construction of the housing shell 103 this can also float.

FIG. 9C shows an enlarged illustration of the handles 122 distributed at the outer periphery of the housing shell 103. As can be clearly seen, the handles 122 are formed bridge-like over a vertical recess 129 of the housing shell 103. Thus, there is sufficient space to thread in for example a round sling or to attach a hook or karabiner for transportation of the generator device 100 at the handles 122.

In FIG. 9D, there is shown an enlarged illustration of the grommets 121 distributed at the outer periphery 128 of the housing shells 103. The grommet 121 is disposed on a lug 130 that in turn extends from a vertical recess 131 of the housing shell 103. Thus, the lug 130 is parallel to the bottom of the housing shell 103. The recess 131 provides for sufficient space for attaching transportation means, theft protections, or pegs at the grommet 121, for example.

### LIST OF REFERENCE NUMBERS

1 generator device
2a,2b solar panel
3a, 3b housing shell
4a,4b peripheral area
5 hinge connection
6 lug
7 lug
8 rail
9 connecting arm
10 panel hinge connection
11 first hinge
12 first end of the connecting arm
13 second hinge
14 second end of the connecting arm
15 slide
16 webs
17 outer periphery
18 adjusting mechanism
19 transport receptacle
20 blocks
21 connecting board
22 handle
23 frame
24 fastening means
102 solar panel
103 housing shell
104 peripheral area
108 perforated strip
109 connecting arm
110 panel hinge connection
111 first hinge
112 first end of the connecting arm
113 receptacle
114 second end of the connecting arm
115 fastening pin
116 chamber
117 opening/valve
118 opening/valve
119 transport receptacle
120 structure
121 grommet
122 handle
123 adjusting mechanism
124 holes
125 filling and discharging facility
126 locking means
127 ventilation opening
128 outer periphery
129 recess
130 lug
131 recess
TP transport position
BP operating position

What is claimed is:

1. A mobile generator device comprising at least one alignable solar panel, wherein the solar panel can be moved in a transport position and at least one operating position,
wherein the generator device has a housing shell with a peripheral area, wherein the solar panel is hinged to the housing shell so that the solar panel is in the transport position within the housing shell and does not project over the peripheral area;
wherein the generator device has a further housing shell with a peripheral area, wherein the further housing shell is connected to the other housing shell by a housing hinge connection so that the peripheral area of the further housing shell can be contacted with the peripheral area of the other housing shell,
wherein the further housing shell has at least one alignable solar panel, wherein the solar panel is hinged to the further housing shell so that the solar panel is in the transport position within the further housing shell and does not project over the peripheral area.

2. (canceled)

3. (canceled)

4. The mobile generator device of claim 1,
wherein the housing hinge connection is detachable.

5. The mobile generator device of claim 2,
wherein each solar panel has a transport locking device so that the solar panel can be fixed in its transport position within the housing shell.

6. The mobile generator device of claim 5,
wherein the generator device for each solar panel has at least one rail disposed within the housing shell and a connecting arm assigned to the rail, wherein the solar panel is connected to one end of the rail by a panel hinge connection and the rail extends vertically to the rotational axis of the panel hinge connection, and the connecting arm at its first end is connected to the solar panel by a first hinge and at its second end is connected to a slide by a second hinge, wherein the slide can be moved along the rail so that the solar panel (2a, 2b) can be continuously aligned towards different operating position.

7. The mobile generator device of claim 6,
wherein the slide can be fixed in its position along the rail.

8. The mobile generator device of claim 7,
wherein the rail is detachably connected to the housing shell.

9. The mobile generator device of claim 5,
wherein each solar panel is connected to the housing shell by at least one panel hinge connection and the housing shell has at least one perforated strip, wherein the perforated strip extends vertically to the rotational axis of the panel hinge connection, and the solar panel has a connecting arm, wherein the connecting arm at its first end is connected to the solar panel by a first hinge, and the connecting arm at its second end has a receptacle for a fastening pin, wherein the connecting arm can be fixed at different positions along the perforated strip via the fastening pin so that the solar panel can be aligned in different operating positions.

10. The mobile generator device of claim 9,
wherein the solar panel is detachably connected to the housing shell.

11. The mobile generator device of claim 10,
wherein the housing shell is made of a weatherproofed material, in particular of polyethylene.

12. The mobile generator device of claim 1,
wherein the housing shell has at least one chamber, wherein the chamber can be filled with material to act as a weight.

13. The mobile generator device of claim 1,
wherein the housing shell has a multi-wall construction, wherein the housing shell has at least one opening for filling and discharging the housing shell.

14. The mobile generator device of claim 1,
wherein at least one housing shell has transport receptacles, in particular for transportation with an industrial truck.

15. The mobile generator device of claim 1,
wherein the housing shell at the outside has structures for safe stacking several housing shells on top of each other.

16. The mobile generator device of claim 1,
wherein the housing shell has at least one grommet for fixation and/or for protection against theft.

17. The mobile generator device of claim 1,
wherein the housing shell has several handles.

18. A cooling system comprising:
a mobile generator device that includes at least one alignable solar panel, wherein the solar panel can be moved in a transport position and at least one operating position,
wherein the generator device has a housing shell with a peripheral area, wherein the solar panel is hinged to the housing shell so that the solar panel is in the transport position within the housing shell and does not project over the peripheral area;
wherein the generator device has a further housing shell with a peripheral area, wherein the further housing shell is connected to the other housing shell by a housing hinge connection so that the peripheral area of the further housing shell can be contacted with the peripheral area of the other housing shell,
wherein the further housing shell has at least one alignable solar panel, wherein the solar panel is hinged to the further housing shell so that the solar panel is in the transport position within the further housing shell and does not project over the peripheral area,
a control,
and a cooling device, in particular a freezer, having at least one cooling circuit, wherein the cooling circuit has a compressor, an evaporator, and a condenser,
wherein the power supply of the cooling system is provided by the mobile generator device and the control regulates the cooling system in dependence of the power supply.
